(19) United States
(12) Patent Application Publication
(10) Pub. No.: US 2026/0192471 A1
(43) Pub. Date: Jul. 9, 2026

(54) SYSTEMS, DEVICES, AND METHODS FOR DETECTING A RIGIDIZED ROBOTIC INTERFACE DURING FREE FLYER OBJECT CAPTURE

(71) Applicant: MacDonald, Dettwiler and Associates Inc., Brampton (CA)

(72) Inventors: Tej Sachdev, Milton (CA); Samir Fahs, North York (CA); Victor Bai, Toronto (CA); Soham Patel, Calgary (CA)

(21) Appl. No.: 18/868,536

(22) PCT Filed: May 26, 2023
(86) PCT No.: PCT/CA2023/050721

§ 371 Date: Nov. 22, 2024

Related U.S. Application Data
(60) Provisional application No. 63/347,863, filed on Jun. 1, 2022.

(51) Int. Cl. B25J 19/02; B25J 13/08; B64G 1/64; B64G 4/00

(52) U.S. Cl. CPC B25J 19/02; B25J 13/085; B64G 1/64; B64G 4/00; B64G 2004/005

(57) ABSTRACT

Provided herein is a system and associated method for use in a grapple fixture for detecting rigidization of a robotic capture interface between a grapple fixture and a robotic arm. The system includes a movable component configured to couple to a mounting end of a grapple probe, a resistance component for resisting movement of the moveable component until a threshold force has been reached, the threshold force correlated to a required preload force of the robotic interface, a detection component, and a triggering component, wherein movement of movable component causes the triggering component to move and effect a state change in the detection component, wherein the threshold force of the resistance component is configured such that it is overcome only once a defined preload of the robotic capture interface has been reached.

### TECHNICAL FIELD

The following relates generally to robotic systems, and more particularly to systems, devices, and methods for detecting a rigidized robotic capture interface.

### INTRODUCTION

Robotic components may be coupled to other robotic systems or components through robotic interfaces. For example, a robotic end effector of a robotic arm or manipulator may be coupled to an object (“capture object”) or payload, such that the object may be manipulated by the robotic arm. Once the object has been manipulated, the object may be uncoupled from the robotic end effector. One application of such systems is in space applications, as the harsh external environment of space may necessitate the use of robotic systems instead of human labour, and the capture of free flyer objects may be of particular necessity in space applications.

Such systems may additionally be implemented in non-space applications, for example underwater/subsea environments, when an object is buoyant within the atmosphere or in free-fall, or wherein a load suspended from a crane that needs to be captured and controlled.

It may be desirable to signal to a system when a robotic interface has been successfully coupled. For example, it may be advantageous to determine at which moment the end effector has been coupled to the object such that the robotic arm may be directed to move. Some current robotic systems comprise systems to detect once such a component coupling has been fully executed. For example, electrical switches may be present within the end effector which may be triggered once an object has been coupled. The circuit associated with such switches may be monitored by on board computer equipment of the robotic arm or associated platform.

It may be advantageous to similarly detect at the object side when the object has been successfully coupled to the end effector. This may be of particular importance in the free flyer object capture case. It may be possible to transmit the known interface status from the end effector portion of the interface to the other side of the interface through a conductive or radio frequency based electrical communication channel. However, such methods may be technically complex, and prone to failure, or may otherwise impact the functionality of the interface.

Additionally, it is preferable if detection of free flyer rigidization does not interfere with free flyer soft capture. For example, some rigidization detection mechanisms may impart a residual force, such that forces are imparted to the free flyer object that may redirect or reorient the free flyer object in space, interfering with the free flyer soft capture process itself. There is a need for a rigidization detection mechanism that imparts a sufficiently small force on the free flyer object prior to soft capture to avoid such capture issues.

Accordingly, there is a need for an improved system and method for detecting a rigidized robotic interface during robotic capture of an object that overcomes at least some of the disadvantages of existing systems and methods.

### SUMMARY

Disclosed herein is a system for use in a grapple fixture for detecting rigidization of a robotic capture interface between a grapple fixture and a robotic arm, according to an embodiment. The system includes a movable component disposed in an interior compartment of a grapple fixture base and movable in a first and a second opposing directions along a first axis, the moveable component configured to couple to a mounting end of a grapple probe such that a force applied to grapple probe along the first axis is applied to moveable component when assembled in the grapple fixture, a resistance component disposed in the interior compartment of the grapple fixture for resisting movement of the moveable component in the first direction along the first axis until a threshold force has been reached, the threshold force correlated to a defined preload force of the robotic interface, a detection component disposed in the interior compartment of the grapple fixture base for registering a first state and a second state, the first state corresponding to a non-rigidized interface state and the second state corresponding to a rigidized interface state, a triggering component configured to move with the moveable component along the first axis, wherein movement of movable component in the first direction causes the triggering component to move in the first direction and effect a state change in the detection component from the first state to the second state and wherein the threshold force of the resistance component is configured such that it is overcome only once a defined preload of the robotic capture interface has been reached.

According to some embodiments, the moveable component is a grapple force transfer component.

According to some embodiments, the resistance component is a spring subsystem including at least one spring.

According to some embodiments, the at least one spring is a wave spring.

According to some embodiments, the at least one spring is two springs.

According to some embodiments, the triggering component is an arm extending generally perpendicularly from an outer surface of the moveable component.

According to some embodiments, the state change comprises a physical contact.

According to some embodiments, the detection component is a contact mechanism.

According to some embodiments, the triggering component includes three arms and the detection component includes three detection components, each detection component configured to register a state based on an interaction with a respective one of the three arms, and wherein the detection component implements a voting architecture to determine a voted output state based on the states registered by the three detection components, wherein the voted output state corresponds to the majority state condition of the three detection components.

According to some embodiments, the detection component includes three contact mechanisms.

According to some embodiments, the triggering component triggers through a non-contact mechanism.

According to some embodiments, the detection component is an optical sensor.

According to some embodiments, the detection component is a capacitance sensor.

Disclosed herein is a method of detecting a rigidized state of a robotic capture interface between a robotic capture device and a grapple fixture through the grapple fixture, according to an embodiment. The method comprises providing a grapple fixture including a probe, a moveable component coupled to the probe, a resistance component coupled to the movable component, a detection component, and a triggering component, resisting movement of the moveable component from a first position to a second position via the resistance component when a pulling force on the probe is less than a defined amount of force, triggering, with the triggering component, a first state change registered by the detection component when the moveable component moves from the first position to the second position, communicating a first state condition from the detection component when the detection component registers the first state change, and returning via the resistance component the moveable component from the second position to the first position when the pulling force on the probe falls below the defined amount of force.

According to some embodiments, the method further comprises triggering, with the triggering component, a second state change registered by the detection component when the moveable component moves from the second position to the first position, and communicating a second state condition from the detection component when the detection component registers the second state change.

According to some embodiments, the resistance component is configured such that the predetermined amount of force is overcome only once a required threshold force of the robotic capture interface has been reached.

According to some embodiments, the resistance component is a spring subsystem including at least one spring.

According to some embodiments, the at least one spring is a wave spring.

According to some embodiments, the at least one spring is two springs.

According to some embodiments, the state change comprises a physical contact.

According to some embodiments, the detection component is a contact mechanism.

According to some embodiments, the detection component includes three contact mechanisms.

According to some embodiments, the detection component is configured to register a state change through a non-contact mechanism.

According to some embodiments, the detection component is an optical sensor.

According to some embodiments, the detection component is a capacitance sensor.

Described herein is a method of assembling a rigidization detection system for detecting a rigidized state of a robotic capture interface between a robotic capture device and a grapple fixture. The method includes providing a grapple fixture base, a probe, a movable component, a resistance component and a detection component, coupling the moveable component to the probe such that when probe moves along an axis, the moveable component moves along the same axis, the moveable component including a triggering component, disposing the resistance component between the moveable component and an interior surface of the grapple fixture base such that resistance component resists movement of moveable component along the axis until a predetermined threshold amount of pulling force is applied to the probe along the axis and returns moveable component to a first position when the pulling force applied to the probe falls below the predetermined threshold amount of force, and disposing the detection component in an interior compartment of the grapple fixture base, the detection component positioned such that it can be triggered by the triggering component, the detection component configured to, when triggered, register a state change and communicate the state change as a signal.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a block diagram of a free flyer object robotic capture system, according to an embodiment;

FIG. 2 is a block diagram of a system for robotic capture of a free flyer object, the system including a base rigidization detection system, according to an embodiment;

FIG. 3 is a block diagram of the base rigidization detection system of the grapple fixture of FIG. 2, according to an embodiment;

FIG. 4A is a flow diagram of a method of detecting that a robotic free flyer capture interface is rigidized using a grapple fixture on the free flyer object, according to an embodiment;

FIG. 4B is a flow diagram of a method of detecting that a robotic free flyer capture interface is rigidized using a grapple fixture on the free flyer object, continued from FIG. 4A, according to an embodiment;

FIG. 5 is a perspective view of a free flyer capture device, according to an embodiment;

FIG. 6 is a perspective view of a grapple fixture configured for capture by the free flyer capture device of FIG. 5, according to an embodiment;

FIG. 7A is a cross sectional view of the grapple fixture of FIG. 6 illustrating a base rigidization detection system in a first, non-rigidized state, according to an embodiment;

FIG. 7B is a zoomed-in cross sectional view of the base rigidization detection system of FIG. 7A;

FIG. 8A is a cross sectional view of the grapple fixture of FIG. 7 illustrating a base rigidization detection system in a second, rigidized state, according to an embodiment;

FIG. 8B is a zoomed-in cross sectional view of the base rigidization detection system of FIG. 8A;

FIG. 9 is a cross sectional view of a robotic capture interface in a non-rigidized state including the free flyer capture device of FIG. 5 and the grapple fixture of FIGS. 6-8 and illustrating the base rigidization detection system in a first non-rigidized state, according to an embodiment;

FIG. 10 is a cross sectional view of the robotic capture interface of FIG. 10 in a rigidized state and illustrating the base rigidization detection system in a second rigidized state, according to an embodiment;

FIG. 11 is a flow diagram of a method of detecting that a robotic free flyer capture interface is rigidized using a grapple fixture on the free flyer object, according to an embodiment; and

FIG. 12 is a flow diagram of a method of assembling a grapple fixture having a robotic capture interface rigidization detection system, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

The term “free flying object”, “free flyer object”, or “free flyer” as used herein refers to an object that is not fixed in an inertial frame. That is, the object is free to move or accelerate in a number of degrees of freedom. Forces resulting from contact with another object will therefore tend to accelerate the free flyer in the opposite direction. Strong initial contact forces during an attempted capture of the free flyer object will tend to “tip off” the object; this is why the robotic capture systems and devices of the present disclosure are configured to perform a “soft capture” (low forces applied at relatively high speed to prevent tip off) and a “hard capture” or “rigidization” (high forces at relatively low speed after tip off has already been prevented by soft capture). Generally, a free flyer object is not physically connected to the “capturing” body, which is the body to which the robotic capture device is connected. The “capturing” body has the ability to control itself in six degrees of freedom (DOF) but has no control of the relative 6-DOF between the capturing body and the free flyer. “Free flyer capture” is the act of gaining control of the relative 6 DOF motion between the capturing body and the free flyer. On Earth, two bodies that are not directly connected do often have an indirect connection through gravity and friction and the ground in between the objects and as such are not unconstrained free flyers. The systems and methods of the present disclosure can be used to facilitate capture in other environments where tip-off of the capture object may occur during a grapple attempt. Additional environments in which the systems and methods may find application include underwater/subsea environments or in space/in-flight, when the object is buoyant within the atmosphere or in free-fall. The systems and methods may be used in Earth-based environments, for example, where some if not all DOFs are uncontrolled. One such example is a load suspended from a crane that needs to be captured and controlled.

Generally, the present disclosure provides systems, methods, and devices for robotic capture of an object including capturing the object by grappling a grapple fixture attached to the object and rigidizing the interface between the end effector and the grapple fixture to establish a load-bearing interface such that the object can be manipulated by a robotic system. The manipulation may include, for example, moving the object from one location to another, or passing any one or more of power, data, or torque through the end effector to the object. The object, referred to herein as a “capture object” or “payload”, may be an object that is not connected to whatever system the robotic arm used to manipulate the end effector is connected to, making alignment generally more challenging. For example, the object may be a free floating underwater object or a free flying object (free flyer object, such as an active, functioning satellite, a decommissioned or failed satellite, a spent upper stage of a launch vehicle, or an orbital debris object). Accordingly, the end effector of the present disclosure may be configured to have a relatively large capture envelope to address potential for misalignment during approach and capture.

The robotic capture systems and devices of the present disclosure may also be used to perform “pick and place” manipulation of objects, grasping an object and enabling moving the object to another location at the end of a robotic manipulator system. The robotic capture systems and devices of the present disclosure may also be used to perform docking of a free-flyer object in which the free-flyer includes an end effector and a larger ‘more stationary’ object includes the grapple fixture. In such a case, a servicer spacecraft may do all the maneuvering without a robotic arm. As such, the free-flyer capture mechanism may reside on either the servicer or the client.

In an embodiment, the end effector is directed by a robotic arm to approach the grapple fixture. The grapple fixture includes a probe having a tip that contacts a probe guiding surface of a receiving end of the end effector. The tip is guided by the probe guiding surface through an opening in the probe guiding surface and into a grappling position. The presence of the probe in the grappling position is sensed by the end effector and a capture mechanism is engaged to grapple the tip of the probe of the grapple fixture. The capture mechanism is retracted, drawing the probe further into the end effector and bringing a base of the grapple fixture into mating contact with the probe guiding surface. The capture mechanism is retracted to a position at which the interface between the grapple fixture and the end effector is rigidized and a desired preload is generated. The captured and rigidized object can then be manipulated by a robotic system, such as by maneuvering the object via the robotic arm.

The foregoing multi-stage capture and rigidization may advantageously allow for an easier and more successful initial capture of the object. The multi-stage approach to capture advantageously allows for rotation of the object during the capture process in order to effect a proper alignment for more fulsome capture. Additionally, in a multi-stage capture and rigidization operation, it is desirable to know when the interface has been fully captured and rigidized. The systems and methods described herein may provide for such capability.

As used herein, the term “end effector” refers generally to a robotic device or element at the end of a robotic arm that performs a function. In the present disclosure, that function includes capturing a free flying or non-free flying asset. The term “end effector” as used herein includes devices that are permanently or non-separably mounted to the end of the robotic arm and devices having a separable interface with the end of the robotic arm. A separable interface may allow the end effector to be picked up, used, and put down (i.e. separated from the robotic arm). Instances of the end effector having a separable interface may also be referred to as a “tool” or “end of arm tool”. In such an instance, the robotic arm may have a first end effector mounted to its end which has the function of a tool-changer that allows the robotic arm to use multiple different tools, and a second end effector having the separable interface and which can be engaged by the first end effector and function as a tool. In such a case, the first “tool-changer” end effector and the second “tool” end effector are each considered an end effector. Accordingly, any references to “end effector” herein are intended to include all devices as described in the foregoing unless otherwise noted.

The systems and methods described herein further allow for detecting a rigidized robotic capture interface between an end effector and a grapple fixture on a free flyer object, through the grapple fixture of the free flyer object. The grapple fixture of the free flyer object is configured such that when the interface has been fully coupled (e.g. achieved soft capture and rigidization/hard capture in a multi-stage capture process), the grapple fixture end of the interface may independently confirm that the interface has been fully coupled, without the use of an electrical communication system communicating across the interface to improve system reliability.

In an embodiment, detection of a rigidized state of the robotic capture interface is achieved using three switches (spaced at 120° with any two switches sufficient to confirm full capture) with mechanical armatures that move when a grapple probe of the grapple fixture is rigidized by the end effector. This design allows for reliable confirmation of full capture. In some cases, this may include a voting architecture implemented as part of the design in which states from a plurality of sensing components (e.g. three) are detected and communicated, each communicated state is counted as a vote, and votes are tallied according to one or more predetermined rules to generate a voted or confirmed state. The solution includes a plurality of wave springs, specifically tuned or selected such that the switches may only be changed in state when sufficient interface preload force has been achieved.

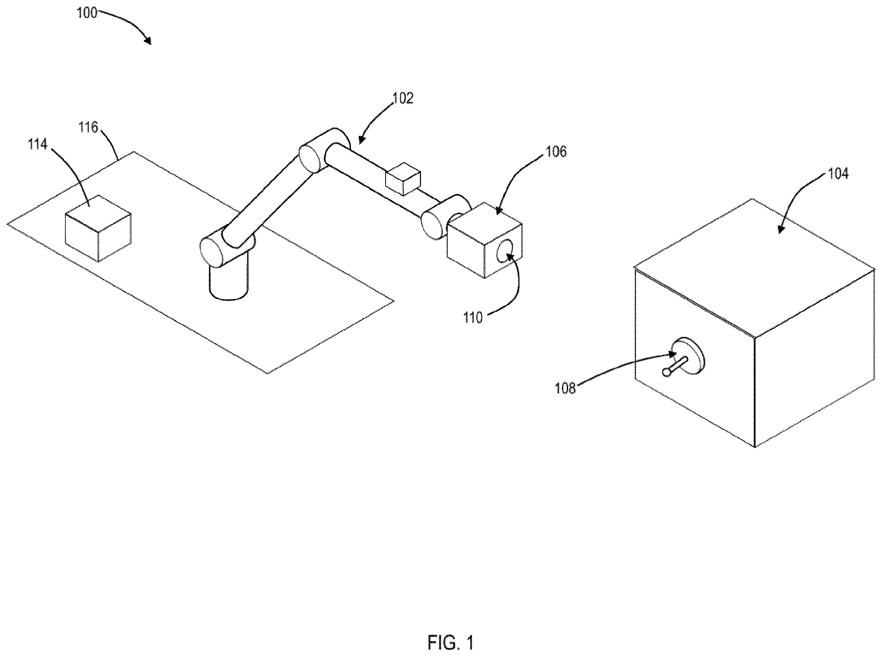

Referring now to FIG. 1, shown therein is a free flyer capture system 100 including a platform 116 and a free flyer object 104, such as a satellite, performing a capture sequence, according to an embodiment.

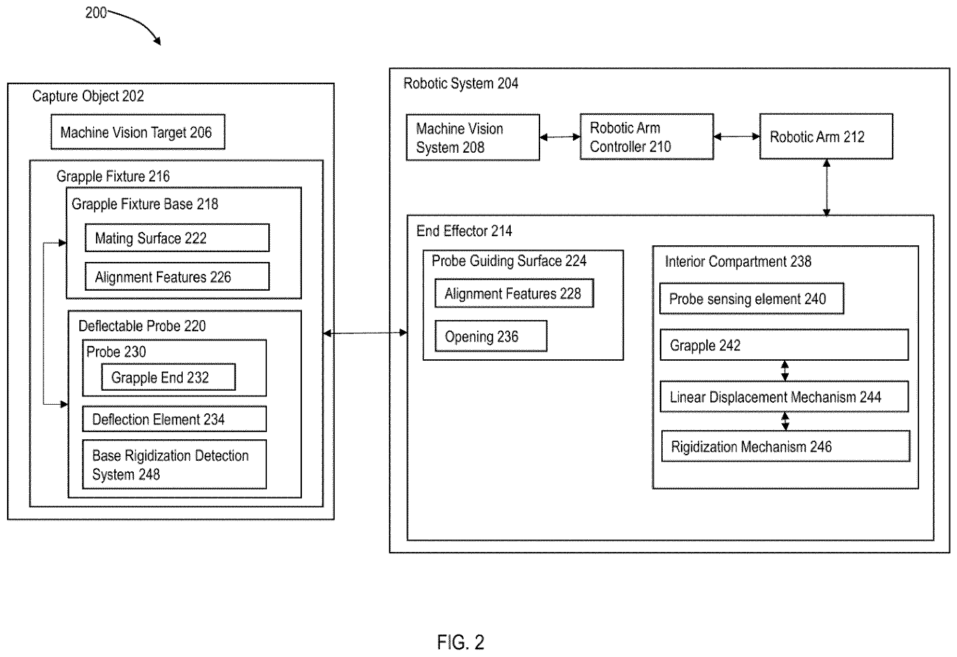

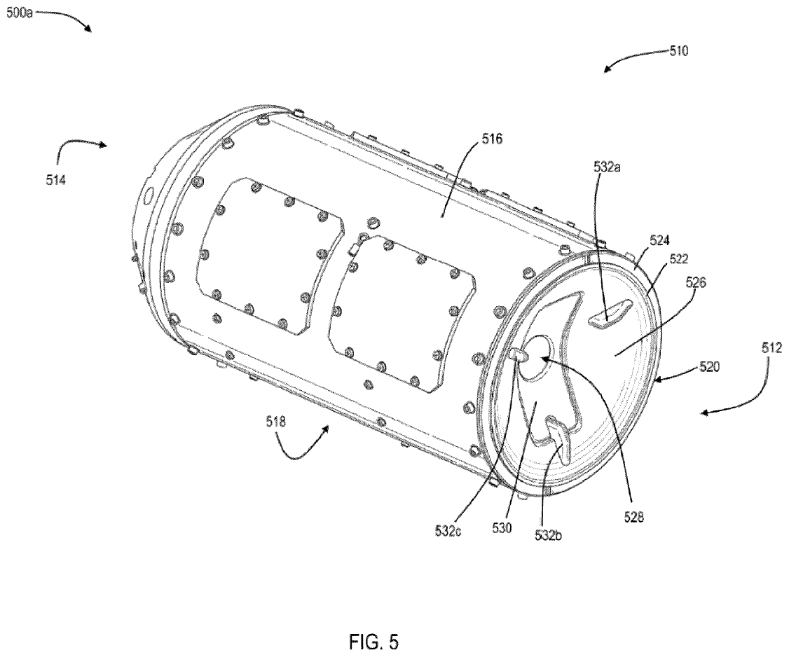

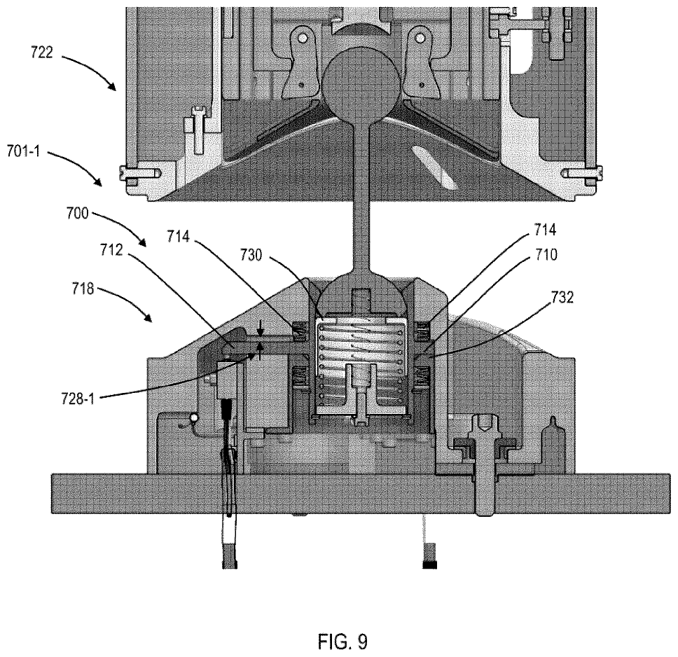

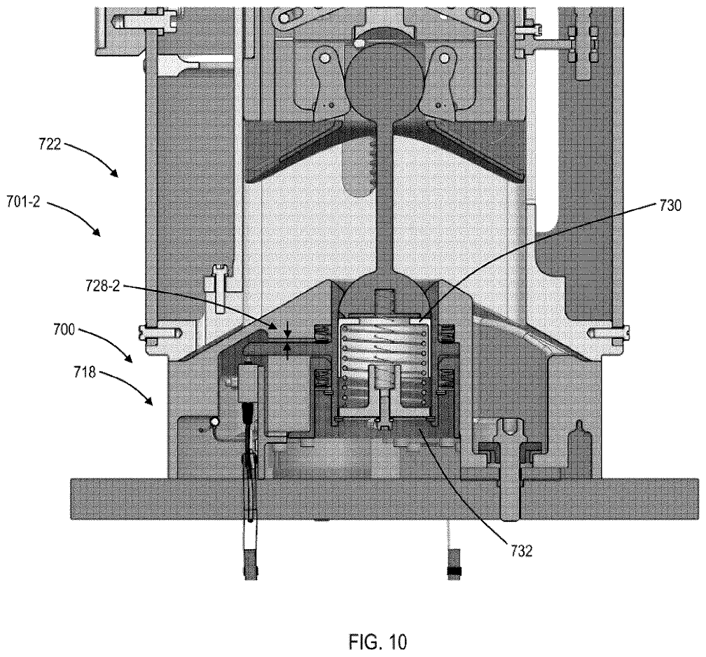

The platform 116 may be a surface of a satellite, space station or other spacecraft. The platform 116 includes a robotic arm 102 and an end effector 106, having a receiving end 110, connected to the robotic arm 102 for performing capture of the free flyer object 104. The end effector 106 may be, for example, the end effector of FIG. 2, the end effector of FIG. 5, or the end effector of FIGS. 9-10. Operation of the robotic arm 102 is controlled via a robotic arm controller 114.

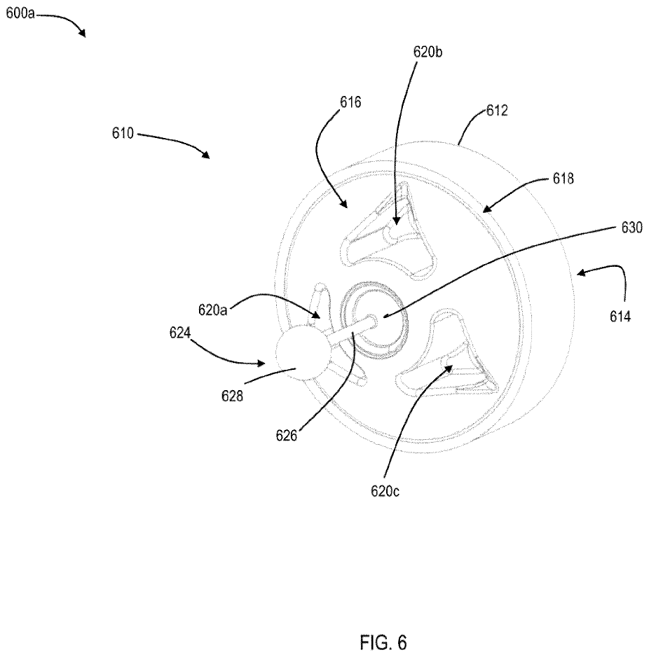

The free flyer object 104 includes a grapple fixture 108 mounted to an exterior surface of the free flyer object 104 for interfacing with the end effector 106. The grapple fixture may be, for example, the grapple fixture of FIG. 2 or the grapple fixture of FIGS. 6-10.

An arm vision system (not pictured) may confirm correct target tracking of the free flyer object 104. This may include tracking a machine vision target on the free flyer object 104. The machine vision target may be located near the grapple fixture 108.

Generally, in operation of the system 100, the robotic arm 102 may be maneuvered such that the end effector 106 is in a position to capture grapple fixture 108 of the free flyer object 104. Afterwards, the receiving end 110 of end effector 106 may grapple the grapple fixture 108 to soft capture free flyer object 104. Next, the interface may be rigidized, such that the grapple fixture 108 is pulled further into receiving end 110, until the free flyer object 104 is secure and preloaded against end effector 106. At this point, the free flyer object 104 may be safely and securely manipulated by the robotic arm 102. The rigidization detection system within the grapple fixture 108 may detect a state of rigidization of the interface, which may then be communicated to other components of grapple fixture 108 and/or components of free flyer object 104.

Referring now to FIG. 2, shown therein is a system 200 for robotic capture of an object, according to an embodiment. The system 200 may be used to capture a free flying object, such as a satellite. In other embodiments, the system 200 may be used to capture a non-free flying object.

The system 200 includes a capture object 202 and a robotic system 204 for capturing the capture object 202 and manipulating the capture object 202 once captured.

The capture object 202 includes a machine vision target 206 on the capture object 202. The machine vision target 206 is positioned on the capture object 202 such that a machine vision system 208 of the robotic system 204 can detect and track the machine vision target 206.

The machine vision system 208 may include a camera for visualizing the machine vision target 206, a processor for generating and processing image data collected by the camera, a memory for storing the image data, and a communication interface for communicating with other components of the robotic system 204 (e.g. communicating information about detection and tracking of the machine vision target 206).

The robotic system 204 also includes a robotic arm controller 210 for controlling movement of a robotic arm 212. The robotic arm controller 210 includes a processor for processing data, a memory for storing data, and a communication interface for communicating with the machine vision system 208 and the robotic arm 212. For example, the robotic arm controller 210 may receive data from the machine vision system 208 regarding the detection and tracking of the machine vision target 206 (and thus, the capture object 202) and generate arm movement commands based on the received machine vision data. The robotic arm controller 210 may then send the arm movement commands to the robotic arm 212 to control movement of the robotic arm 212.

In some cases, the robotic arm controller 210 may be configured to determine a relative approach velocity and maintain the relative approach velocity within a predetermined range for promoting soft capture of the capture object 202.

The robotic system 200 also includes an end effector 214 connected to the robotic arm 212. The end effector 214 is configured to capture (grapple and rigidize) the capture object 202 via a grapple fixture 216 on the capture object 202. The end effector 214 may also be configured to pass any one or more of power, data, and torque to the capture object 202 through interfaces present on the capture object 202 once captured.

The grapple fixture 216 may be mounted to the capture object 202 at a location near the machine vision target 206 such that the machine vision target 206 can be used to direct the end effector 214 towards the grapple fixture 216 for capture.

The grapple fixture 216 includes a base 218 and a deflectable probe 220 connected to the base 218.

The base 218 is mounted to an external surface of the capture object 202. The deflectable probe 220 is connected to the base 218 such that the deflectable probe, when at rest (i.e. in a non-deflected state), is generally perpendicular to the base 218.

The base 218 includes a mating surface 222 configured to interface and mate with a probe guiding surface 224 of the end effector 214 during capture. The mating surface 222 includes one or more alignment features 226. The alignment features 226 are configured to interface with complementary alignment features 228 on the probe guiding surface 224. The alignment features 226 are configured to promote alignment of the grapple fixture 216 and the probe guiding surface 224 through contact with the alignment features 228. The alignment features 226, 228 may be used to generate required preload of the end effector-grapple fixture interface. In some embodiments, preload may only be on a subset of the alignment features 226, 228 (or only a subset of alignment features may be used to react loads at the interface). For example, in a particular embodiment the alignment features 228 may include a raised contacting annulus and a plurality of alignment fins with complementary alignment features 226 on the grapple fixture, and only the annulus is used to react loads at the interface (preload only at contact annulus, not fins; ‘annulus reaction’). In another embodiment, the annulus may be absent, and the alignment fins may be used to react loads at the interface (‘fin reaction’). The alignment features 226, 228 may be used to provide rotational and shear alignment of the grapple fixture 216 and end effector 214 when bringing the two together. The alignment features 226, 228 may also be configured to allow for some level of offset (e.g. lateral, rotational) between the grapple fixture 216 and the end effector 214 during capture. This may be particularly advantageous in applications where the capture object 202 has a tumble rate, such as in the case of a free flyer object. The alignment features 226, 228 may be configured to cause self-alignment of the interface as a result of rotational misalignment (e.g. 5 degrees offset).

The deflectable probe 220 of the grapple fixture 216 includes a probe 230 including a shaft that terminates at a grapple end 232. The grapple end 232 may have a diameter greater than a diameter of the shaft. The grapple end 232 may comprise a spherical tip. In cases where the grapple end is rounded or spherical, the grapple end 232 may be referred to as a “grapple ball”.

The deflectable probe 220 also includes a deflection element 234 for enabling deflection of the probe 230 in the direction of an applied force. The deflection element 234 is also configured to return the probe 230 to a resting state (non-deflected state, no applied force) when the applied force is removed. The amount of applied force required to deflect the deflection element 234 may vary depending on the material used. In an embodiment, the deflection element comprises one or more springs.

The deflection element 234 is connected to the probe 230 and the base 218 to facilitate deflection relative to the base 218. In some cases, the probe 230 may also be directly attached or mounted to the base 218.

The deflectable probe 220 further includes a base rigidization detection system 248. The base rigidization detection system 248 is configured to detect a rigidized state of the robotic capture interface between the grapple fixture 216 and the end effector 214 at the grapple fixture end of the interface. The base rigidization detection system 248 may be configured to generate and communicate a signal to a secondary subsystem on the capture object 202 (not shown) such that a state of the robotic capture interface (i.e. rigidized, not rigidized) can be communicated to the secondary subsystem. The secondary subsystem may be configured to change a state or perform an action or operation based on the received signal (e.g. release a captured or connected payload).

Generally, as the robotic arm 212 moves the end effector 214 towards the grapple fixture 216 of the capture object 202, the grapple end 232 of the deflectable probe 220 contacts the probe guiding surface 224 of the end effector 214.

The probe guiding surface 224 is curved to promote deflection of the deflectable probe 220 towards an opening 236 upon contact with the grapple end 232. The opening 236 may be located at or near the center of the probe guiding surface 224. In cases where the probe guiding surface 224 is concave, the opening 236 may be located at a vertex of the concave probe guiding surface 224.

The probe guiding surface 224 is composed of a material suitable to enable the grapple end 232 of the deflectable probe 220 to slide along the probe guiding surface 224. For example, the material may be selected to have suitable frictional force interaction between the probe guiding surface 224 and the grapple end 232. Similarly, the grapple end 232 is composed of a material suitable to enable the grapple end 232 to slide along the probe guiding surface 224 at a desired or acceptable level of friction.

Generally, the movement of the end effector 214 towards the grapple fixture 216, the deflection of the deflectable probe 220, and the shape and surface composition of the probe guiding surface 224 and grapple end 232 act together to guide the grapple end 232 through the opening 236 and into an interior compartment 238 of the end effector 214 for grappling.

The interior compartment 238 houses a probe sensing element 240, a grapple 242, a linear displacement mechanism 244, and a rigidization mechanism 246.

The probe sensing element 240 is configured to sense the presence of the grapple end 232 of the probe 230 and trigger the grapple 242 to grab the grapple end 232.

The probe sensing element 240 is positioned near the opening 236 such that, when triggered by the grapple end 232 (such as by, for example, being depressed by or otherwise contacted by the grapple end 232), the grapple 242 can grab the grapple end 232. For example, in an embodiment, the grapple 232 may include a pair of jaws which are in an open state until triggered to close by the probe sensing element 240. The probe sensing element 240 is positioned such that, in order for the grapple end 232 to trigger the probe sensing element 240 (e.g. by physical contact therewith), the grapple end 232 enters and occupies a space between the open jaws (“grapple position” or “soft capture position”). The jaws can then be closed to grapple the grapple end 232.

The grapple 242 may be configured to constrain three degrees of freedom (linear motion) of the grapple fixture 216 upon grappling the grapple end 232 of the probe 230.

The linear displacement mechanism 244 is configured to translate the grapple 242 along a capture axis of the end effector 214. Once the grapple 242 has grabbed the grapple end 232 of the deflectable probe 220, the linear displacement mechanism 244 retracts the grapple 242 (and the grappled probe 230) in a direction opposite the receiving end of the end effector 214. The retraction of the grapple 242 draws the deflectable probe 220 further into the interior compartment 238, which brings the mating surface 222 and alignment features 226 of the grapple fixture base 218 closer to and into contact with the probe guiding surface 224. As previously noted, in some embodiments, only a subset of alignment features 226 may contact.

In an embodiment, the linear displacement mechanism 244 includes two ball screws, a ball nut attached to each ball screw, and a motor for driving rotation of the ball screws. The ball nuts are attached to the grapple 242, and as the ball screw rotates the grapple 242 is translated via the ball nuts. By using two ball screws, the ball screws can be placed beside the rest of the mechanism, on each side, with balanced loads making the tool shorter. This design can be particularly advantageous in robotic arm operations where a longer package (e.g. using a single ball screw instead of the two ball screws) is not preferred. Nevertheless, in other embodiments, a single ball screw may be used.

The linear displacement mechanism 244 is configured to retract the grapple 242 to a hard capture position. As the grappled deflectable probe 220 is retracted, the angular and lateral offsets of the capture object 202 are removed. Hard capture (rigidization) of the grapple fixture 216 is achieved when the probe 220 is retracted to a point at which the grapple fixture 216 is preloaded against the probe guiding surface 224 of the end effector 214. This may include contact and mating of the alignment features 226, 228. In particular, the interior compartment 238 includes a rigidization mechanism 246 for rigidizing the interface between the grapple fixture 216 and the end effector 214. In an embodiment, the rigidization mechanism 246 includes a compressible element (e.g. Belleville spring stack) which is compressed via retraction of the probe 220 by the linear displacement mechanism 244 to a preload position (corresponding to a compression of the compressible element). The compressible element may be a spring based compliant member.

The compressible element provides a known stiffness deflection relationship. The use of the compressible element (e.g., Belleville stack) allows for keeping the load variation controlled. There are several effects that can cause loads to change once in the hard-capture or rigidized position. These effects include temperature, where the coefficient of thermal expansion (CTE) of the structure is different from the mechanism so a change in temperature causes a change in the position of the mechanism relative to the structure. This is particularly relevant when used in environments, such as space, where temperature can change drastically (e.g., −40 to +100° C.). The effects causing loads to change once hard-captured also include, for example, variation in length of the grapple probe from fixture to fixture and position variation/accuracy within the capture tool. The compressible element is a lower stiffness compliance that allows the hard capture load to be controlled passively without constant monitoring.

The capture mechanism may include a state change detection element for detecting when soft capture and retraction of the grapple fixture has been achieved and rigidization should be initiated using the preload generator component. In an embodiment, the state change detection element includes a potentiometer configured to detect when the grapple end 232 has reached a “seated” position. The state change detection element is connected to and triggers the preload generator element. In an embodiment, when the soft capture indicator is tripped, the mechanism moves immediately to rigidize (hard capture) so that the interface cannot drift out of alignment before it comes together. The preload generator element may then be compressed until a desired (predetermined) preload is achieved. A power off brake may be used to avoid continuously losing power while holding onto the free flyer object (payload) when power is cut to the drive motor. Generally, the system is calibrated (e.g., on ground in a space application) to go to a specific position as the “hard-capture position”, which is a position that can only be attained (while holding a grapple fixture) by compressing the preload generator element (e.g., spring stack). In an embodiment using a spring stack, a middle point (or an approximate middle point) in the stroke of the stack may be used so that the varying effects (such as described above) do not move the rigidization load outside of a range. That range is based on the external loads that are to be reacted once rigidized (i.e., no separation of the interface) and the strength of the components in the system.

Once rigidized, the end effector 214 may send a signal to the robotic arm controller 210 that the capture object 202 is rigidized. The robotic arm controller 210 may then manipulate the robotic arm 212 by generating and sending arm movement commands to move the rigidized capture object 202 to a desired location.

The linear displacement mechanism 244 may also be used to release the grapple fixture 216 by driving the grapple 242 (or components thereof) forward along the capture axis to drive the grapple 242 into the open position, enabling release of the grapple end 232 and thus the grapple fixture 216.

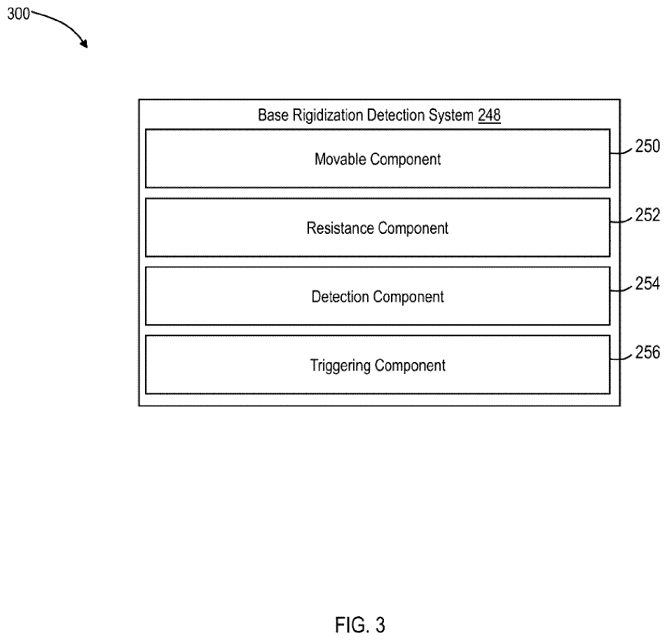

Referring now to FIG. 3, shown therein is a system block diagram 300 detailing subcomponents of base rigidization detection system 248, as referred to in FIG. 2, according to an embodiment.

Base rigidization detection system 248 includes a moveable component 250, a resistance component 252, a triggering component 256, and a detection component 254.

Base rigidization detection system 248 comprises a plurality of components, that in cooperation, may enable the system 200 to detect whether rigidization of the robotic capture interface between end effector 214 and grapple fixture 216 has been successfully achieved at the grapple fixture 216 end of the interface.

Base rigidization detection system 248 may generate a mechanical or electrical signal at the grapple fixture 216 which may be communicated to and/or read or processed by other components of grapple fixture 216 or capture object 202. For example, an electrical signal may be generated which may activate another component, or be detected by an onboard computer system, microcontroller or other electronic device.

Moveable component 250 comprises a physical component coupled to probe 230 such that linear translational motion of probe 230 along an axis or axes may be transferred to movable component 250. For example, if probe 230 is moved in a certain direction, movable component 250 may also move proportionally along the same axis. In a particular example, if probe 230 is grabbed and pulled by the end effector 214, the movable component 250 may experience the same applied force through its coupling to probe 230. Moveable component 250 may be restricted in movement to a single direction and or linear axis, and the range of motion of movable component 250 may be limited.

Triggering component 256 comprises a physical component coupled to movable component, which may move proportionally to movable component 250 when moveable component 250 is moved. In some examples, triggering component 256 may be integrated into movable component 250, such that triggering component 256 and movable component 250 comprise a single integrated part. For example, the triggering component 256 may comprise an arm extending from the moveable component 250. The arm may, for example, extend from the movable component 250 at an angle generally perpendicular to a longitudinal axis of the probe 230 when the probe 230 is in a resting state (e.g. non-deflected).

Resistance component 252 comprises a component positioned between grapple fixture base 218 and moveable component 250. Resistance component 252 is coupled to, or otherwise positioned between both grapple fixture base 218 and moveable component 250 such that a resistive force is added to any movement of movable component 250. For example, resistance component 252 may comprise a mechanical spring or plurality of mechanical springs which apply a resisting force to movement of movable component 250 along a specific linear axis. Resistive force of resistance component 252 may be tuned or selected such that the level or amount of resistive force applied to movable component 250 is known or aligned with other aspects of system 200. In some examples, resistance component 252 may comprise at least one wave spring. In a particular embodiment, resistance component 252 may comprise two wave springs. Wave springs may be particularly advantageous as they may be of a smaller volume and mass than other comparable springs or mechanical resistance components with given specifications. Such properties may be particularly advantageous in space applications, as reduced mass and volume may result in reduced launch costs and system capability.

Detection component 254 comprises a component that may alter or generate a signal in response to rigidization. Detection component 254 may disposed within base 218 of grapple fixture 216. Detection component 254 may be configured to register a first state and a second state. Detection component 254 may register a state change, such as from the first state to the second state or vice versa, based on some physical interaction with triggering component 256. For example, in some embodiments, triggering component 256 may activate and/or actuate detection component 254 as triggering component 256 moves. In an example, movement of triggering component 256 from a first position to a second position may cause detection component 254 to register a state change from a first state to a second state, and vice versa. For example, triggering component 256 may physically contact detection component 254 in the first position (registering a first state) and no longer physically contact detection component 254 in the second position (registering a second state). Generally, detection component 254 generates and communicates a different signal in each of the first and second states, which in some cases may simply be no signal/signal. In some examples, the detection component 254 may include a plurality of detection components to improve reliability.

In some examples, detection component 254 may comprise a contact mechanism detection component such as a switch or a strain gauge.

In some examples, switches may be miniature snap-action switches. A miniature snap action switch may refer to an electric switch that is actuated by very little physical force, such as through the use of a tipping-point mechanism, which may be referred to as an “over-center” mechanism. In some examples, the miniature snap-action switches may be Micro Switch™ branded switches or the like.

In some examples, detection component 254 may comprise a non-contact mechanism detection component, such as an optical sensor, capacitive sensor, a laser-based sensor or a proximity sensor. In some examples, detection component 254 may comprise multiple of, or a combination of, the components described above.

In some examples, detection component 254 be configured, such that instead of a discrete and/or binary state change, the detection component 254 may detect a continuous state. In such examples, detection component 254 may be a strain gauge, potentiometer, or other component which may register a continuous state. In such an example, a position on the continuous spectrum of state may be selected as the state change point, such that states greater or lesser than this state change point may be considered a first state or a second state respectively, or vice versa.

In an example, probe 230 may be moved along a linear axis. Through a physical connection between probe 230 and movable component 250, movable component 250 will be moved proportionally to the movement of probe 230, along this same axis. The movable component 250 may have a restrictive force applied to it by resistance component 252, such that a certain elevated amount of force must be applied to move probe 230, and by extension, movable component 250. Resistance component 252 is configured such that when a force is applied to probe 230 by grapple 242 during the rigidization process, a sufficient amount of force is applied to probe 230, such that moveable component 250 moves a sufficient distance (e.g. from a first position to a second position) to activate a switch of detection component 254. In some examples, triggering component 256 may move in tandem with movable component 250 to activate the switch. Once this switch is activated, a circuit may be open or closed, which may be detected by an associated computer system or microcontroller. In other examples, the switch may generate a pulse or signal that may similarly be detected by an associated computer system or microcontroller.

The base rigidization detection system 248 eliminates any force on the capture object 202 until soft capture is complete, minimizing interference with the free-flyer capture process. The rigidization detection process of the present disclosure relies on a change of state which is driven by a change of position of the associated base rigidization detection system 248 components. The position of the associated base rigidization detection system 248 components may change without imparting a force on capture object 202 until soft capture is complete. The base rigidization detection system 248 does not detrimentally impact soft capture forces (e.g. tip-off of a free flyer) and may change state only when all degrees of freedom are constrained between the free flyer and the grapple fixture and a predetermined amount of preload is achieved at the interface. Such a configuration renders the base rigidization detection system 248 particularly well adapted to free flyer object capture, as impacts to the free flyer object capture process are minimized.

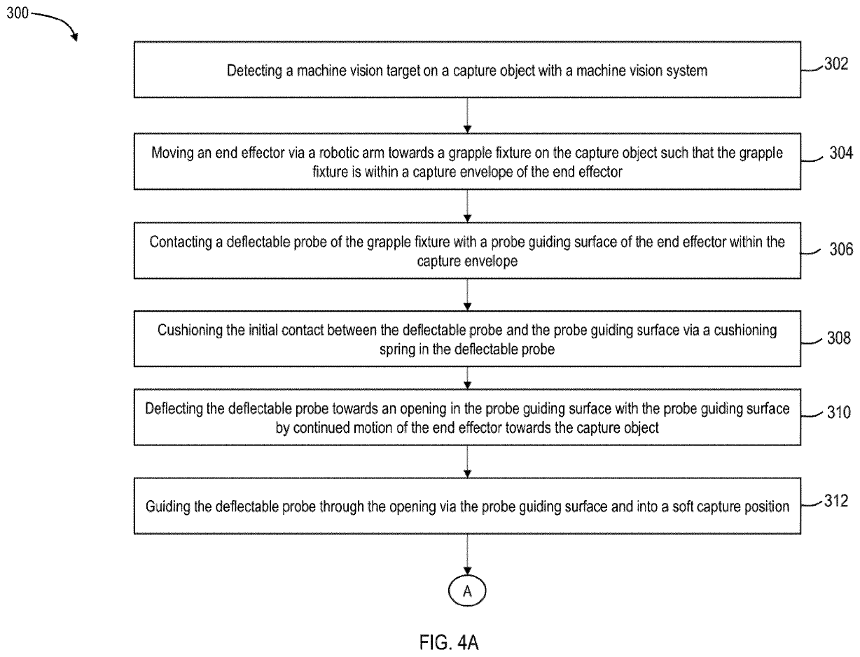

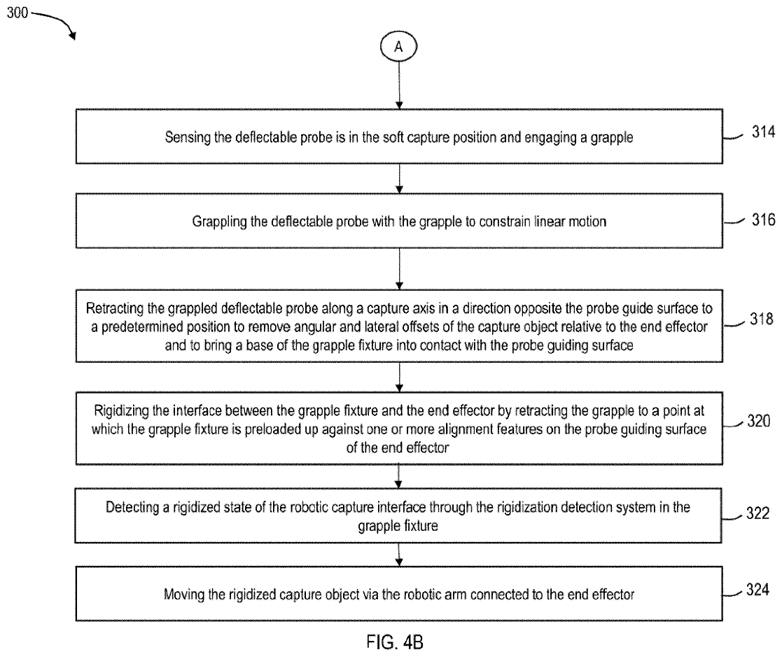

Referring now to FIGS. 4A and 4B, shown therein is a method 300 of robotics-based object capture, according to an embodiment. The method 300 may be performed using a robotics system including a machine vision system, a robotic arm controller, a robotic arm, and an end effector, such as system 200 of FIG. 2. In an embodiment, the method 300 may be used to capture a free flyer object in a space-based application, such as a satellite or the like.

At 302, a machine vision target mounted on an object to be captured (“capture object”) is detected by the machine vision system. The capture object may be a free flyer object. The machine vision system may then generate a signal that the capture object has been detected and communicate the signal to the robotic arm controller.

In some cases, the capture object may also be referred to as a “target object”. The object or vehicle performing the capture via the end effector, and to which the end effector is connected, may be referred to as a “chaser”. For example, in a space-based application, the chaser may be a spacecraft.

At 304, the robotic arm moves the end effector towards a grapple fixture on the capture object. The grapple fixture is used to enable grappling and capture of the capture object and may be a standardized interface. The robotic arm controller is configured to control the movement of the robotic arm at 304 such that the grapple fixture is within a capture envelope of the end effector as the end effector approaches the grapple fixture.

The term “capture envelope” as used in the present disclosure will now be described. When a capture or docking device is being positioned for use, the device needs to be placed in a certain relative position with respect to the grapple element or fixture of the capture object in order to ensure that, when the soft capture operation is executed, the mechanism will successfully close around the grapple fixture. While the capture operation is occurring, there are a number of effects that work against successful capture, including that the mechanism itself has certain geometric and dynamic positioning requirements, the vision system has a certain amount of measurement uncertainty, and the capture object is still potentially drifting with respect to the capture system's platform. Adding up all these effects (potential errors) yields a positioning requirement in x, y, z, yaw, pitch, roll that the capture mechanism must be inside to guarantee capture. This is referred to as the “capture envelope”. The larger the capture envelope, the more objects can be captured for a given set of these effects (drift rates, targeting and positioning accuracy, system speed to keep up with a ‘tumbling’ or ‘drifting’ FF). Also there can be a minimum “capture envelope” required based on the effects in the system that work against capture. A larger envelope gives margin on the ability to capture making the free flyer capture sequence more reliable.

The machine vision system may continue to track the capture object via the machine vision target and communicate with the robotic arm controller to keep pace with the capture object and perform a final inward (towards the capture object) motion guided by the target to get the grapple fixture (e.g., a probe tip of the grapple fixture) within the capture envelope. For example, the robotic arm controller may control the robotic arm to close in on the capture object at a prescribed rate. This may include tracking the capture object and, as the capture object is drifting, the robotic arm controller controls the arm to keep pace such that there is a constant vector between the end effector and the capture object. At an appropriate point, the robotic arm controller may then add a delta command. The delta command represents the closing velocity to bring the receiving end of the end effector towards the grapple fixture of the capture object. The delta command may include closing in within a particular velocity range (e.g., predetermined band, as described below).

The robotic arm controller may be configured to move the robotic arm and end effector towards the capture object at a prescribed rate such that the relative velocity of the end effector and the capture object are maintained within a predetermined band. The predetermined band represents a range of relative velocities which are known to promote or result in successful soft capture of the grapple fixture (e.g., through sliding along the probe guiding surface and through the opening into the interior compartment, as described below). The predetermined relative velocity band may be determined based on a variety of system characteristics (including characteristics of the robotic system and the capture object). Such system characteristics may include, for example, characteristics of a deflectable probe of the grapple fixture such as spring stiffness or frictional characteristics of the probe and the probe guiding surface. Maintaining the relative velocity of the capture object and the end effector on approach can be particularly important in free flyer capture applications as having such relative velocity be too fast or too slow can cause failure to have the probe of the grapple fixture contact the probe guiding surface, deflect, and slide on the probe guiding surface through the opening into the interior compartment for grappling.

It is important that a useful capture device be forgiving with respect to the relative velocity between the capture system and the capture object. Much of the robotic capture system design is driven by factors or principles such as reducing friction, minimizing spring stiffness, reducing tip off forces, and increasing the speed of action of the soft capture. The need to achieve rigidization sometimes infringes on these driving principles. For example, fins on the capture device that ensure good constraints on roll after capture (e.g. fins 532 of FIG. 5) can create an impediment to soft capture which has been mitigated to an extent by the design to keep the capture envelope as large as possible and reduce the relative rate requirement on the capture system. The means of achieving roll constraint in the rigidized state necessarily will compromise the largest possible capture envelope of the design and getting that envelope as large as possible adds margin to successful soft capture capacity. The device of the present disclosure accommodates misalignment through a flexible member within the capture system. The deflection of the flexible member (probe) to correct the misalignment occurs on contact with the free flyer object. It takes a small amount of energy (in the form of force-times-displacement) to deflect the flexible member into alignment. If the approach is too slow, the free flyer object will be pushed away from the end effector capture device before “soft-capture” can be achieved. The minimum rate at which capture can still be achieved is based on the inertia of the free flyer (mass and rotational mass-inertia) and the trigger force of the soft capture mechanism itself. Thus, the capture system is configured to achieve a minimum relative rate between the capture tool (chaser side) and the grapple fixture (free flyer side) for effective capture.

At 306, a deflectable probe of the grapple fixture contacts a probe guiding surface on a receiving end of the end effector within the capture envelope.

At 308, the initial contact between the deflectable probe and the probe guiding surface at 306 is cushioned by a cushioning spring in the deflectable probe. Such cushioning of the initial impact may prevent the probe from bouncing off of the receiving end of the end effector. This may be particularly advantageous in applications where the capture object is a free flyer object.

At 310, the deflectable probe is deflected by the probe guiding surface from a resting position (e.g. probe perpendicular to the surface of the capture object on which the grapple fixture is mounted) towards an opening in the probe guiding surface located at or near the center of the probe guiding surface by the continued motion of the end effector towards the capture object. The probe guiding surface may be concave to promote deflection of the deflectable probe in the direction of the opening. The opening provides entry by the deflectable probe to an interior compartment of the end effector in which a capture mechanism is disposed.

The deflectable probe includes a deflection element for enabling the probe to deflect from a resting position in the direction of an applied force and to return to the resting position upon removal of the applied force. In the case of 110, the shape of the probe guiding surface and the motion of the end effector towards the capture object applies a force to the deflectable probe which deflects the probe in the direction of the opening in the probe guiding surface. The deflectable element may include one or more spring components to facilitate deflection.

At 312, the probe guiding surface guides the deflected probe through the opening and into a soft capture position (or grapple position) in the interior compartment. The continued motion of the end effector towards the capture object and the profile of the probe guiding surface causes the continued deflection of the deflectable probe and sliding of the end of the deflectable probe across the probe guiding surface towards and through the opening.

At 314, the presence of the deflectable probe in the soft capture position is sensed by the end effector, triggering a grapple mechanism (“grapple”) of the end effector.

In an embodiment, the sensing of the deflectable probe may be performed by positioning a sensing element or trigger in line with the capture axis (the axis on which the deflectable probe is oriented in the interior compartment of the end effector) which is contacted by the end of the deflectable probe as the deflectable probe enters the opening and into the interior compartment of the end effector. The force applied to the sensing element by the contact of the deflectable probe may then cause the sensing element to engage the grapple.

Any suitable method for sensing the presence of the probe may be used and the type of sensing is not particularly limited. For example, in variations, sensing the presence of the probe may be achieved via any one or more of force tripping a switch, force as measured by an appropriately placed load cell/strain gauge, optical methods, capacitive methods, inductive methods, and electrical resistive methods. Force tripping of a switch may advantageously provide a simple and effective way of measuring state change. Other sensing methods can in general be employed in other embodiments.

At 316, the deflectable probe is grappled by the grapple. Grappling of the deflectable probe constrains linear motion of the capture object relative to the end effector. In an embodiment, the grapple may include a pair of jaws configured to move from an open position to a closed position when triggered, thereby grabbing the probe. In an embodiment, the end of the probe is spherical to enable grappling of the probe (and also to promote sliding of the probe along the probe guiding surface).

At 318, the grappled deflectable probe is retracted in the interior compartment of the end effector along a capture axis in a direction opposite the receiving end of the end effector to remove angular and lateral offsets of the capture object relative to the end effector. Generally, in some embodiments, roll misalignment must be maintained within a specified maximum value between soft capture and rigidize. It is possible that after soft capture, if the roll misalignment continues to grow beyond the maximum allowable misalignment, rigidize may not occur. The grappled probe may be retracted to a predetermined position. The predetermined position may be detected by a potentiometer or the like. Retraction of the grappled probe brings a base of the grapple fixture, which is connected to the deflectable probe, further towards and into contact with the probe guiding surface. The base of the grapple fixture and the probe guiding surface may be complementarily shaped to promote sliding of the base along the probe guiding surface and/or mating of the base to the probe guiding surface. The grapple fixture base and the probe guiding surface may each include alignment features configured to interface with one another and promote alignment between the grapple fixture base and the probe guiding surface as the probe is retracted and the end effector and capture object are moved closer together.

At 320, the interface between the grapple fixture and the end effector is rigidized. Rigidization is achieved by retracting the grapple to a point at which the grapple fixture is preloaded up against one or more alignment features on the probe guiding surface of the end effector. For example, in some embodiments, preload may be on a contacting annulus, as described herein. In other embodiments, preload may be on a plurality of protrusions (or ‘fins’). In a particular embodiment, alignment features include a raised contacting annulus and a plurality of fins, and the grapple fixture is preloaded against the raised contacting annulus and not the alignment fins.

Rigidization of the interface allows for complete authority by the capturing system to define the relative position and orientation of the capture object. This allows for low uncertainty of, and control of, the relative position and rates between the two objects. This state is typically preferred for situations where the robotic servicer is then going to apply loads while it fixes, adjusts, or refuels the captured object or the robotic servicer is propelling the capture object into a new orbit or into a new attitude. In the soft capture state, the capture system has some authority over the capture object in certain DOF but not others (so it does not have an ability to generate a force or moment against the free flyer object in order to maneuver it into any position and orientation). Once achieved, the hard capture or rigidized state provides the ability to generate forces and moments in all directions against the capture object (e.g. like holding a handle mounted to the object). Having 6-DOF and being determinant in where the free flyer is being held allows handling of the object and alignment of the object with other connecting features or other servicing features such as robotic servicing systems, refueling systems, or the like.

At 322, a rigidized state of the robotic capture interface is detected through the rigidization detection system in the grapple fixture, as described herein. The state of the robotic capture interface may be communicated to other components of the system, through the grapple fixture.

At 324, the rigidized capture object is manipulated (e.g. moved) by the robotic arm connected to the end effector. In an example, the capture object may be moved to a berthing position.

Referring now to FIG. 5, shown therein is a front perspective view 500a of an end effector 510 for capturing a free flyer object, according to an embodiment. The end effector 510 may be the end effector 106 of FIG. 1 or the end effector 214 of FIG. 2.

The end effector 510 may be used to capture a free flyer object such as a client spacecraft having a grapple fixture, such as grapple fixture 216 of FIG. 2, mounted thereto. Generally, the end effector 510 is configured to capture the free flyer object by capturing and rigidizing the grapple fixture of the free flyer object.

The end effector 510 includes a receiving end 512 and a robotic arm interfacing end 514. The receiving end 512 is configured to interface with and capture a grapple fixture mounted to the free flyer object being captured. The robotic arm interfacing end 514 is configured to connect the end effector 510 to a robotic arm for manipulation of the end effector 510 via the robotic arm. Accordingly, the robotic arm interfacing end 514 may include various mechanical or electrical connections for facilitating the manipulation and operation of the end effector 510 via the robotic arm.

In some cases, the end effector 510 may include components enabling the end effector 510 to be engaged by another end effector. For example, the end effector 510 may include a grapple fixture mounted thereto for capturing the end effector 510 by the second end effector. The end effector 510 may also include one or more interfaces for passing power, data, or torque from the second end effector to the end effector 510.

The end effector 510 includes an outer housing 516. The outer housing 516 of end effector is generally cylindrical in shape. In other embodiments, the outer housing 516 may have any other suitable shape. The outer housing 516 may include any number of pieces or components. The outer housing 516 encloses an interior compartment (not shown) in which various components for the operation of the end effector, including for capture and rigidization of the free flyer grapple fixture, are disposed.

The end effector 510 also includes a stow/launch interface component 518 (not visible in FIG. 5). The stow/launch interface component 518 may comprise a docking port for putting the end effector 510 down in a known location (e.g. on a spacecraft). The known location may have access to power or umbilical connection with heaters through the stow/launch interface component 518.

The end effector 510 includes a front end component 520 mounted to the outer housing 516 at the receiving end 512 for interfacing with the grapple fixture of the free flyer object.

The front end component 520 includes a raised annulus 522 extending around the periphery of the front end component 520 for contacting a complementary annulus on the base of the grapple fixture (e.g. 618 as shown in FIG. 6). The raised annulus 522 comprises a piece of material that is raised in profile relative to an outer annulus 524 of the front end component 520. The raised annulus 522 provides uniform distribution of clamping load and equal load-bearing capacity independent of applied pitch/yaw loads. In some embodiments, the raised annulus 522 may not be present.

The front end component 520 also includes a probe guiding surface 526. The probe guiding surface 526 is concave and includes an opening 528 for receiving a probe of a grapple fixture in order to position the probe in the capture mechanism. The opening 526 is positioned generally at the center of the probe guiding surface 526 (e.g. at a vertex of the concave surface). The probe guiding surface 526 is configured to passively guide the probe of the grapple fixture into the opening 528 upon the probe contacting the probe guiding surface 526. The system controlling the end effector 510 may be configured to cause the end effector 510 to approach the grapple fixture of the free flyer object at parameters (e.g. relative velocity, relative angle) known to promote successful guiding of the probe into the opening 528 via the probe guiding surface 526 (e.g. without having the probe bounce off the surface 526 due to such parameters). The management of such parameters by the control system of the end effector 510 may be particularly critical in free flyer object capture applications, where the potential for a misaligned grapple fixture to cause the free flyer object to bounce off the end effector 510 is more prevalent.

Features of the probe guiding surface 526, such as the material and angle of the surface, may be selected to achieve a desired interaction with the probe of the grapple fixture. For example, the features may be selected to achieve a desired level of friction or to more efficiently guide the contacting probe towards and into the opening 528.

The probe guiding surface 526 includes a concave insert 530. The concave insert 530 is moveable along a capture axis as part of a capture mechanism in the interior compartment of the end effector 510. For example, the concave insert 530 may be the forward most (proximal to the receiving end 512) component of the capture mechanism. In FIG. 5, the concave insert 530 is in a full forward position and will retract along the capture axis towards the arm interfacing end 514during the capture sequence.

The concave insert 530 may be composed of the same material and have the same surface properties as the rest of the probe guiding surface 526. The concave insert 530 may simply be a continuation of the probe guiding surface 526 that is mounted to a section of the device that retracts to move from soft capture to hard capture (rigidize). In other embodiments, the probe guide surface 526 may be a single piece (i.e. where the surface is continuous rather than an outer surface plus the insert). However, using a single piece for the probe guiding surface 526 instead of the concave insert 530 may result in interference with the grapple probe as the grapple probe is drawn inwards to align the interfaces. As such, embodiments using the concave insert 530 may advantageously avoid such interference.

The front end component 520 also includes three protrusions or “fins” 532a, 532b, 532c (referred to collectively as fins 532 and generically as fin 532) mounted to the probe guiding surface 526.

The fins 532 act as alignment features that help align the receiving end of the end effector 512 with the grapple fixture of the free flyer object. The fins 532 are configured to mate with complementary alignment features (pockets 620 shown in FIG. 6). For example, when capturing the grapple probe of the free flyer object, there may be some level of offset present attributable to the free flyer object having a tumble rate. The capture mechanism capturing and retracting the probe of the grapple fixture may provide coupling but may be translationally misaligned by an amount (e.g. a couple inches). The fins 532 enable the grapple fixture and front end component 520 to come together in alignment even where the free flyer object is rotationally misaligned by an amount. In such cases, the fins 532 are designed to slide down rounded edges of the respective pockets (triangle cutouts) of the grapple fixture base to sit inside the pockets. In doing so, the fins 532 (along with the pockets of the grapple fixture) give rotational and shear alignment of the grapple fixture and front end component 520 when bringing the two together. The fins 532 thus provide a mechanism for correcting rotational misalignment and for performing self-alignment. In an embodiment, the fins (and pockets) are configured to align a rotational offset of up to 5 degrees. In some embodiments, such as where the front end component 520 does not include the raised annulus 522, the interface may be grounded on the fins 532. In such embodiments, three fins 532 are used for determinism. In embodiments where the interface is grounded on the raised annulus 522, the number of fins 532 may vary. In such cases, a minimum of two fins 532 may be used on the front end component 520 for rotational alignment about the central axis.

The fins 532 have rounded surfaces enabling the fins 532 to travel down rounded edges of the complementary pockets. Fins 532 may be dry lubed. Lubrication may be selected based on suitability for the operational environment. The fins 532 may also have one or more round surfaces or angled corners to promote guiding or deflection of the ball of the grapple probe towards the opening 528 upon the probe contacting the fin 532.

Embodiments of the front end component 520 which include the raised annulus 522 for grounding the interface may provide particular advantages (e.g. over embodiments grounding the interface on the fins 532). Contacting at three points (such as in the case of grounding on the three fins 532) means that in certain directions the stance at which bending loads are reacted is quite small (centerline to the line between two fins), whereas the annulus 522 is always maximizing the stance to react the loads regardless of direction.

Referring now to FIG. 6, shown therein is a front perspective view 600a of a grapple fixture 610 for mounting to a free flyer object (or other object to be captured) and for capture by and mating with the end effector 510 of FIG. 5, according to an embodiment.

The grapple fixture 610 includes a base 612.

The base 612 includes a mounting surface 614 for mounting the grapple fixture 610 to an external surface of the free flyer object (or other object, as the case may be).

The base 612 also includes a mating surface 616 opposing the mounting surface 614 for mating with or coupling to the probe guiding surface 526 of the end effector 510. The mating surface 616 is convex in shape. The curve of the mating surface 616 may be configured to match or substantially match the curve of the probe guiding surface 526 of the end effector 510, such that the two surfaces are complementary in shape.

The mating surface 616 of the base 612 includes a flat annular portion 618 extending around the periphery of the mating surface 616 for contacting and mating with the raised annulus 522 of the end effector 510 upon capture.

The mating surface 616 also includes recesses (or pockets or cutaway portions) 620a, 620b, 620c (referred to collectively as recesses 620 and generically as recess 620) for promoting alignment between the grapple fixture 610 and the front end component 520 of the end effector 510. In particular, the recesses 620 are positioned on the mating surface 616 and configured to receive respective fins 532 on the end effector 510. The recesses 620 are triangular. In other embodiments, the recesses 620 may be any other suitable shape. Triangular-shaped recesses or openings may advantageously reduce likelihood that fins 532 will contact the grapple fixture 610 prior to soft capture. The edges of the recesses 620 provide a guide towards the bottom of the fin alignment “V” shaped feature. This is provided by a triangular cut-out. The recesses 620 have a flat or non-flat bottom surface and curved or rounded side surfaces. The curved side surfaces promote sliding of the fin 532 to the bottom surface and into the desired position. In some embodiments, the fins 532 do not go to and contact the bottom surface (for example, in an annulus reaction embodiment in which the annulus is used to react loads at the interface and the fins 532 are not) but rather a clearance (e.g. slight) is left between the fin 532 and the bottom surface within an acceptable alignment variance.

In some embodiments, each recess 620 may include a fastener (not shown) therein passing from the bottom surface of the recess 620 through to the mounting surface 614. The fasteners are used to mount the base 612 of the grapple fixture 610 to the free flyer object. The fasteners may be buried out of the way so that the fasteners do not interact with the fins 532. In an embodiment, the grapple fixture 610 may include isolation (thermal and electrical) under the fasteners and also between the grapple fixture base 618 and the object to which the grapple fixture 610 is mounted (e.g., spacecraft).

The grapple fixture 610 also includes a deflectable probe 624 mounted to the base 612. The deflectable probe 624 includes a shaft 626, a spherical (or ball) shaped end 628 connected to a first end of the shaft 626, and a mounting end 630 connected to a second end of the shaft 626. In variations, the probe end 628 may have different shapes.

The deflectable probe 624 is connected to a deflection element for enabling the deflectable probe to deflect from a rest position in the direction of an applied force and return to the rest position when the force is removed (the probe 624 is shown in the rest position in FIG. 6). The rest position may be substantially perpendicular to the base 612. The deflection element includes one or more springs for enabling deflection. In some embodiments, the deflection element used to make the probe 624 deflectable may be any suitable mechanical spring in compression, a pneumatic component (e.g. in marine applications), an actively tensioned component, a nullspring, or a flexible shaft (on shaft 626).

The deflectable probe 624, is additionally connected to a base rigidization detection system within grapple fixture 610 (e.g. base rigidization detection system 248 (not pictured in FIG. 6), such that rigidization may be detected from within grapple fixture 610 (i.e. on the capture object side of the robotic capture interface).

The deflectable probe 624 may also include a coaxial spring (not shown). The coaxial spring is used for electrostatic shock conduction. The coaxial spring electrically connects the probe 624 to the base 612 of the grapple fixture 610. The coaxial spring permanently connects the probe 624 electrically to the base 612 of the grapple fixture 610. When the probe tip 628 contacts the conical interface on the end effector during capture (surface 526 of FIG. 5), the coaxial spring then electrically connects the servicer ground to the free flyer ground through a dissipative resistor. This enables charge to flow, but with greatly reduced current so as to limit damage. This approach is used as dry-lubrication in the ‘knuckle-joint’ of the probe 624 is likely to be insulating. The coaxial spring may enable the capture system to be used in geosynchronous and other high orbits that have environmental conditions that lead to electrostatic charging of objects. For example, when two objects with different charge levels come into contact, large electrostatic discharge events can occur which can endanger avionics and power systems on either object (e.g. on the capture system side or the free flyer side).

The coaxial spring connects to the deflectable probe 624 at the mounting end 630. The grapple fixture 610 may further include a spring mounting component. The spring mounting component may include one or more pieces. The coaxial spring and a deflection spring are attached to the spring mounting component and the spring mounting component is mounted to the base 612 via the mounting surface 614. The spring mounting component may function as a spring retainer.

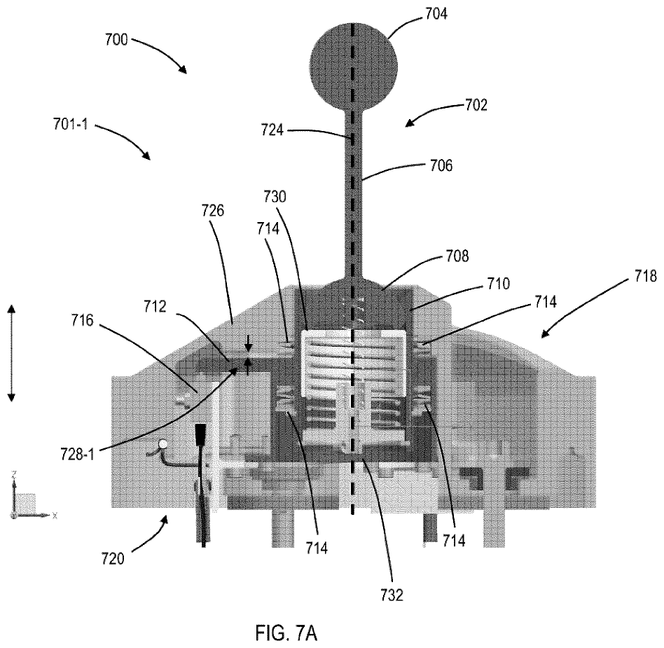

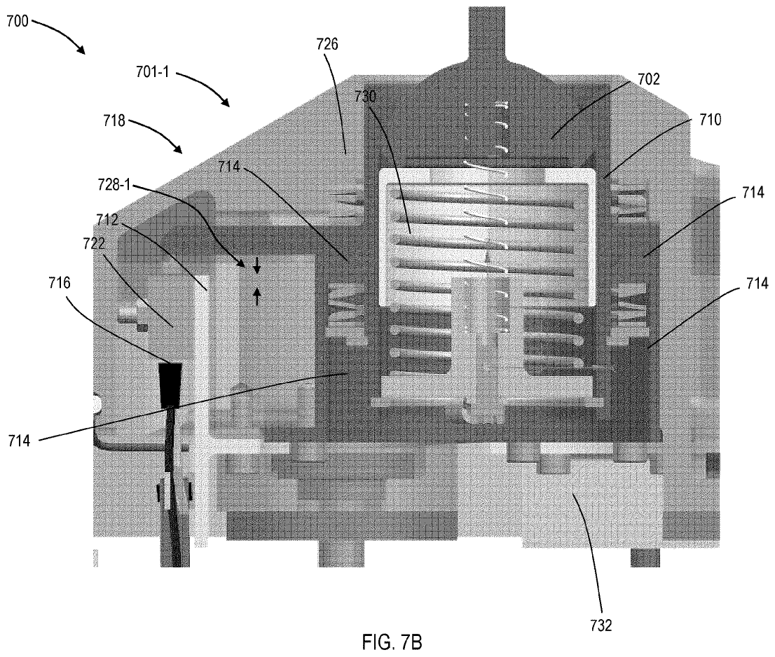

Referring now to FIGS. 7 to 10, shown therein is a system 700 for robotic capture including grapple fixture 718 and end effector 722, according to an embodiment. Description above in reference to FIGS. 1 to 6 may apply to system 700 of FIGS. 7 to 10. Grapple fixture 718, and end effector 722 correspond to grapple fixture 610 and end effector 510 respectively.

FIGS. 7A and 7B show a cross sectional view of grapple fixture 718 in isolation in a non-rigidized state 701-1. Grapple fixture 718 further includes a probe 702, movable component 710, resistance component 714, and detecting element 716, resistance housing 730 and resistance guide 732. Probe 702 further includes a probe end 704, probe mounting end 708, and probe shaft 706.

Resistance housing 730 houses a spring that allows probe 702 to deflect during mating of grapple fixture 718 to end effector 722. Any lateral or angular misalignment of grapple fixture 718 to end effector 722 will cause the probe 702 to deflect, producing a resultant force pushing axially on the resistance housing 730. The spring within resistance housing 730 will bias probe 702 towards a neutral position, such that probe 702 will return to a neutral position when no external force is applied to probe 702. Resistance housing 730 additionally returns to a neutral position when misalignment between grapple fixture 718 to end effector 722 is corrected, removing external forces on probe 702.

Resistance guide 732 houses a portion of resistance component 714 and guides the movable component 710 along the axial direction, during a mating a rigidizing operation.

Movable component 710, according to an embodiment, comprises a generally cylindrical sleeve, coupled to probe 702. The movable component 710 may be coupled to the probe 702 via an axial compression spring contained within resistance housing 730. The force of compressing the axial spring causes the surface of probe mounting end 708 to come into contact with the adjacent concave surface of movable component 710. As previously described, a preload force may exist between resistance housing 730 and probe 702 to bias probe 702 to a neutral position, wherein probe 702 is generally coaxial with a first axis 724. The two contacting surfaces of probe mounting end 708 and resistance housing 730 may be treated (for example, dry lubricated) to minimize friction during probe 702 deflection. In some examples, interfacing or contacting surfaces of movable component 710 may also be treated (for example, dry lubricated) to minimize friction during movement.

The movable component 710 is disposed within an interior compartment of the base 726 of grapple fixture 718. The movable component 710 may be generally moved along first axis 724 within the base 726 of the grapple fixture 718. First axis 724 is generally coaxial with probe 702 when probe 702 is in a neutral or otherwise undeflected position. The movable component 710 may be manufactured from metal, polymer, ceramic, or any other suitable material.

In the embodiment of FIGS. 7A and 7B, movable component 710 may be referred to as a grapple force transfer component. The grapple force transfer component is configured to receive a force from the grapple mechanism of an end effector, through a probe (e.g. probe 702) and transfer this received force to a triggering component (e.g. arms 712), such that a state change may be effected in a detection component (e.g. detection component 716).

Coupled to movable component 710 are three arms 712 (only one is visible in FIG. 7). In other embodiments, the number of arms may vary depending on the number of detection components (as described herein). In some examples, each arm 712 may be referred to as a triggering component. Each arm 712 extends generally away from movable component, in a direction perpendicular to first axis 724. Each arm 712 is disposed within an interior cavity of the grapple fixture 702 base 726. As movable component 710 moves along first axis 724, each arm 712 will move in the same direction, along a parallel axis. In the embodiment of FIGS. 7-10, each arm 712 is integrated into movable component 710, however, in other embodiments, each arm 712 may be a separate component fastened to movable component 710.

Arms 712 may be separated from base 726 by a distance 728-1 in the non-rigidized state 701-1. As the system transitions from the non-rigidized state 701-1 to the rigidized state 701-2, distance 728-1 may be decreased as arms 712 move with moveable component 710 in the direction of the probe 702.

Resistance component 714 is positioned between movable component 710 and grapple fixture base 726. Resistance component 714 may be coupled to both movable component 710 and grapple fixture base 726, such that resistance component 714 applies a resisting force to any movement of movable component 710. In the example of FIGS. 7-10, resistance component 714 comprises four wave springs.

Additionally, resistance component 714 is positioned between movable component 710 and resistance guide 732. Detection component 716 comprises a switch 722. When an arm 712 contacts switch 722, the state of the switch will be altered from a first state to a second state, and vice versa. In the embodiment of FIGS. 7-10, grapple fixture 718 includes three detection components 716, each positioned 120° apart from one another around the generally cylindrical moving component 710. In other examples, other types or number of detection components may be used in grapple fixture 718, and in other configurations or arrangements.

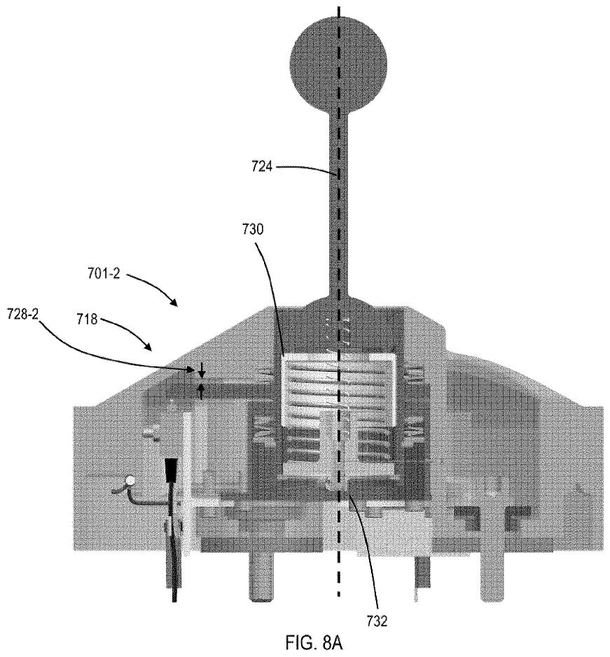

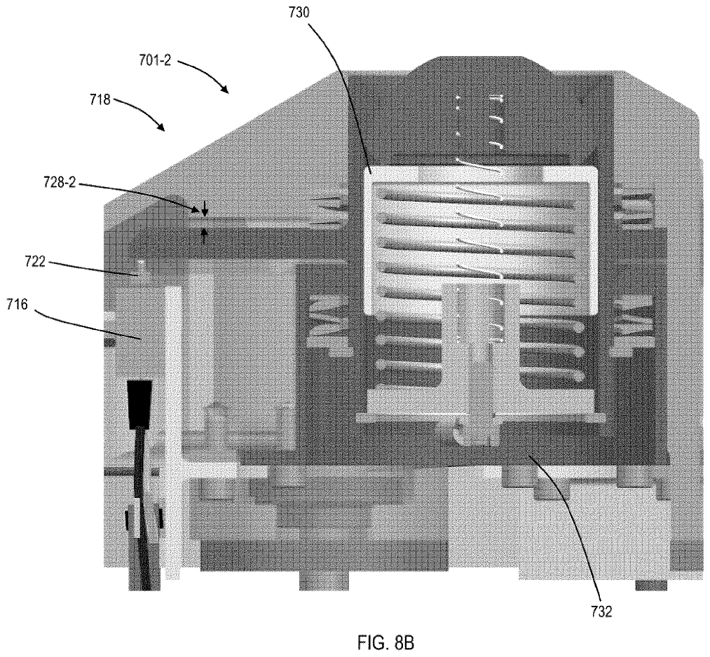

FIGS. 8A and 8B show a cross sectional view of grapple fixture 718 in isolation in a rigidized state 701-2. As seen in FIGS. 8A and 8B, in the rigidized state 701-2, the distance 728-2 is smaller than the distance 728-1 of the non-rigidized state 701-1. Movable component 710 has been forced upwards along axis 724, through movement of probe 702 in the same direction along the same axis 724. This upwards movement has been imparted into arms 712, moving arms upwards along an axis parallel to axis 724, such that the arms have been lifted off the detection component 716, such that switch 722 registers a second (rigidized) state. In some examples, wherein system 700 comprises three detection components 716, a plurality of logic gates (e.g. AND gates, OR gates, etc.) may be packaged together such that a single output or signal of system 700 may be read indicating a majority state of the three detection components (i.e., a voting architecture). For example, when two of three detection components 716 register a first state, the single output may register a first state. When three of three detection components 716 register a second state, the single output may register a second state.

FIGS. 9 and 10 show a cross sectional view of grapple fixture 718 and end effector 722 conducting a capture and rigidization operation, as described by method 300 of FIGS. 4A and 4B. When grapple fixture 718 and end effector 722 are brought together such that grapple fixture 718 and end effector 722 may be coupled, the grapple of end effector 722 may grapple the probe 702 of grapple fixture (after the interface has been placed into the pre-capture position 701-1 as shown in FIG. 9). Once grappled, the grapple may retract linearly back into end effector 722, applying a force to probe 702, retracting probe 702, and therefore, grapple fixture 718 into the opening of end effector 722, as shown in FIG. 9. A first amount of force may be applied to grapple fixture 718 to retract the probe 702 into the end effector 722. Once the base of the grapple fixture is in contact with the probe guiding surface, a second amount of force may be subsequently applied to achieve interface preload, wherein the grapple fixture 718 is held against end effector 722 with force (and the interface is rigidized).

This second force may be greater than the first force. The resistance component 714 is configured such that a sufficient amount of resistance is applied to any movement of movable component 710, wherein only a force that is greater than the first amount of force is applied to the probe 702 to achieve preload, that the movable component 710 may move a sufficient distance to produce a state change of detection component 716. This configuration may be achieved by adjusting the total mechanical spring coefficient of resistance component 714. This amount of force may be less than the second amount of force in some examples.

For example, in an embodiment, the first amount of force may be 180 N. 180 N may be continuously applied to probe 702 along axis 724, such that the probe 702 may be pulled into the end effector 722 by the grapple of the end effector 722. Once the end effector 722 and grapple fixture 718 surface have reached contact, the force applied to the probe 702 by the end effector may be increased. For example, the force may be continuously increased at a constant rate, from 180 N to a final force of 500 N. This final force of 500 N may be the second amount of force as referred to above. In some examples, this second amount of force (500 N) may be referred to as the preload force, as this may be the amount of force between the surfaces of end effector 722 and grapple fixture 718.

The resistance components 714 may be configured such that a sufficient amount of resistance is applied to any movement of movable component 710, wherein only a force that is greater than (or equal to, in some examples) 300 N (e.g., threshold force) may effect a change of state in each detection component 718 from the first non-rigidized state 701-1 to the rigidized state 701-2. This state changing force of 300 N may be lower than the final expected 500 N preload force. While this force of 300 N may not reflect a true maximally rigidized state, selecting a state changing force lower than the final 500 N preload force may advantageously reduce nuisance trips of the detection components when other loads are applied to the probe 702 through the end effector 722. For example, a high weight component may impart additional forces on the probe when manipulated by the robotic arm coupled to the end effector 722 (e.g., sudden stops of the robotic arm during movement). It is undesirable for such forces to change the detected state of the interface if the interface may withstand such loads (e.g., the interface is still mated, and has not been separated). Therefore, this force buffer may provide for greater rigidization detection system performance.

In the example of FIGS. 7-10, resistance component 714 includes an upper half and a lower half. The force applied to probe 702 must first be sufficiently high to overcome the resistance of the lower half of resistance component 714, and then subsequently, the force must be sufficiently high to compress the upper half of resistance component 714. Once the upper half of resistance component 714 has been compressed, a state change may be registered by detection component 716.

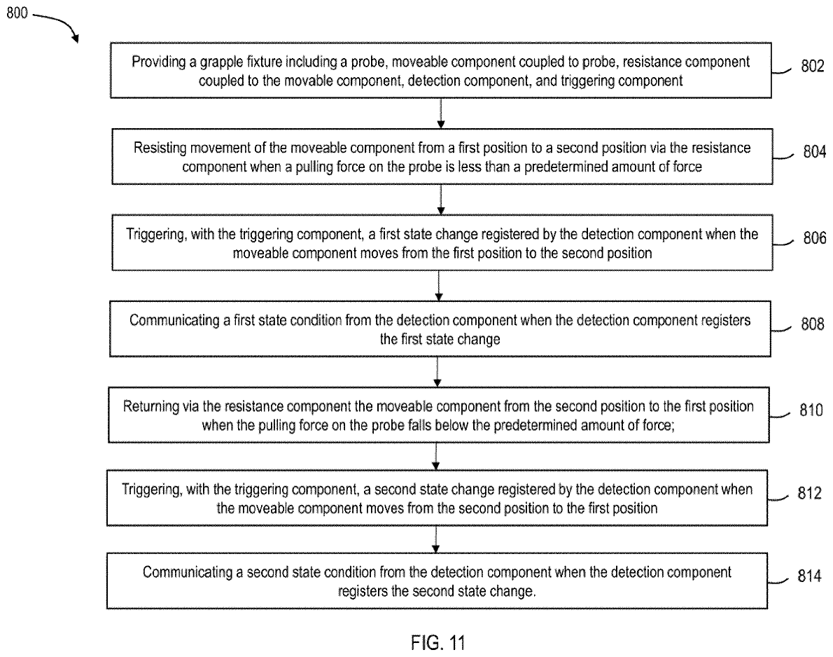

Referring now to FIG. 11, shown therein is a flow chart describing a method 800 of detecting a rigidized state of a robotic capture interface between a robotic capture device and a grapple fixture through the grapple fixture, according to an embodiment. The method 800 may be implemented by a grapple fixture rigidization detection system, such as the system of FIGS. 7-10 and the base rigidization system of FIGS. 2-3. Method 800 includes 802, 804, 806, 808, 810, 812, and 814. Method steps may be performed in any order in some embodiments.

At 802, the method 800 includes providing a grapple fixture including a probe, moveable component coupled to probe, resistance component coupled to the movable component, detection component, and triggering component.

At 804, the method 800 includes resisting movement of the moveable component from a first position to a second position via the resistance component when a pulling force on the probe is less than a predetermined amount of force.

At 806, the method 800 includes triggering, with the triggering component, a first state change registered by the detection component when the moveable component moves from the first position to the second position. Movement from the first position to the second position occurs when the predetermined amount of force is reached.

At 808, the method 800 includes communicating a first state condition from the detection component when the detection component registers the first state change.

At 810, the method 800 includes returning via the resistance component the moveable component from the second position to the first position when the pulling force on the probe falls below the predetermined amount of force.

At 812, the method 800 includes triggering, with the triggering component, a second state change registered by the detection component when the moveable component moves from the second position to the first position.

At 814, the method 800 includes communicating a second state condition from the detection component when the detection component registers the second state change.

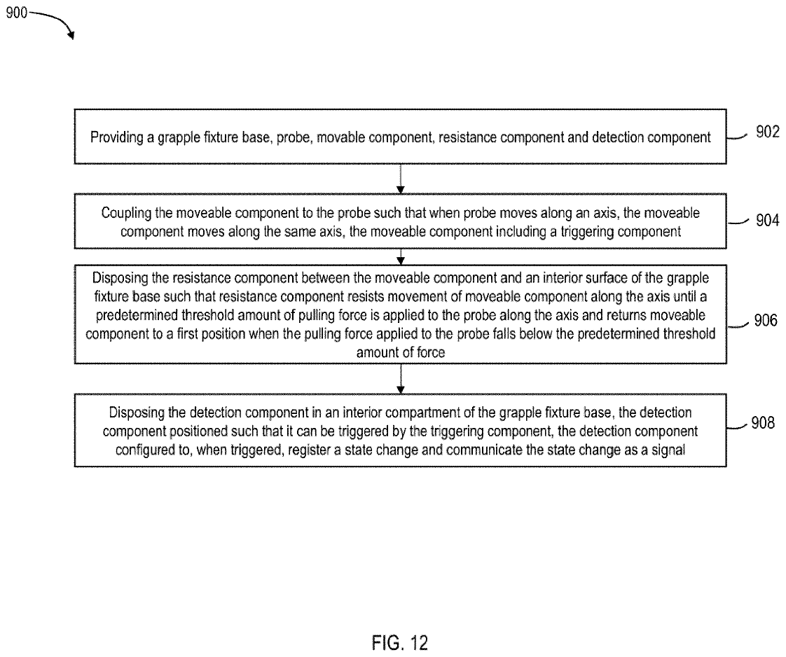

Referring now to FIG. 12, shown therein is a flow chart describing a method 900 of manufacture or assembly of a grapple fixture rigidization detection system, according to an embodiment. The grapple fixture rigidization detection system may be the system of FIGS. 7-10 or the base rigidization system of FIGS. 2-3. Method 900 includes 902, 904, 906, and 908. Method steps may be performed in any order in some embodiments.

At 902, the method 900 includes providing a grapple fixture base, probe, movable component, resistive component and detection component.

At 904, the method 900 includes coupling the moveable component to the probe such that when the probe moves along an axis, the moveable component moves along the same axis, the moveable component including a triggering component.

At 906, the method 900 includes disposing the resistance component between the moveable component and an interior surface of the grapple fixture base such that resistance component resists movement of moveable component along the axis until a predetermined threshold amount of pulling force is applied to the probe along the axis and returns moveable component to a first position when the pulling force applied to the probe falls below the predetermined threshold amount of force.

At 908, the method 900 includes disposing the detection component in an interior compartment of the grapple fixture base, wherein the detection component is positioned such that the detection component can be triggered by the triggering component, and wherein the detection component is configured to, when triggered, register a state change and communicate the state change as a signal.

While the above description provides examples of one or more apparatus, methods, or systems, it will be appreciated that other apparatus, methods, or systems may be within the scope of the claims as interpreted by one of skill in the art.

1. A system for use in a grapple fixture for detecting rigidization of a robotic capture interface between a grapple fixture and a robotic arm, the system comprising:
a movable component disposed in an interior compartment of a grapple fixture base and movable in a first and a second opposing directions along a first axis, the moveable component configured to couple to a mounting end of a grapple probe such that a force applied to the grapple probe along the first axis is applied to moveable component when assembled in the grapple fixture;
a resistance component disposed in the interior compartment of the grapple fixture base for resisting movement of the moveable component in the first direction along the first axis until a threshold force of the resistance component has been reached, the threshold force correlated to a defined preload force of the robotic capture interface;
a detection component disposed in the interior compartment of the grapple fixture base for registering a first state and a second state, the first state corresponding to a non-rigidized interface state and the second state corresponding to a rigidized interface state; and
a triggering component configured to move with the moveable component along the first axis, wherein movement of the movable component in the first direction causes the triggering component to move in the first direction and effect a state change in the detection component from the first state to the second state; and
wherein the threshold force of the resistance component is configured such that the threshold force is overcome only once the defined preload of the robotic capture interface has been reached.

2. The system of claim 1, wherein the moveable component is a grapple force transfer component.

3. The system of claim 1, wherein the resistance component is a spring subsystem including at least one spring.

4. The system of claim 3, wherein the at least one spring is two springs positioned around the movable component.

5. The system of claim 1, wherein the triggering component is an arm extending generally perpendicularly from an outer surface of the moveable component.

6. The system of claim 1, wherein the state change is triggered by a physical contact between two components.

7. The system of claim 6, wherein the detection component is a contact mechanism wherein the state change is registered on the physical contact between the two components.

8. The system of claim 5, wherein the triggering component includes three arms and the detection component includes three detection components, each detection component configured to register a state based on an interaction with a respective one of the three arms;
wherein the detection component implements a voting architecture to determine a voted output state based on the states registered by the three detection components; and
wherein the voted output state corresponds to a majority state condition of the three detection components.

9. The system of claim 1, wherein the triggering component triggers through a non-contact mechanism wherein the state change is registered without physical contact between components.

10. The system of claim 9, wherein the detection component is an optical sensor.

11. The system of claim 9, wherein the detection component is a capacitance sensor.

12. A method of detecting a rigidized state of a robotic capture interface between a robotic capture device and a grapple fixture through the grapple fixture, the method comprising:
providing a grapple fixture including a probe, a moveable component coupled to the probe, a resistance component coupled to the movable component, a detection component, and a triggering component;
resisting movement of the moveable component from a first position to a second position via the resistance component when a pulling force on the probe is less than a defined amount of force;
triggering, with the triggering component, a first state change registered by the detection component when the moveable component moves from the first position to the second position;
communicating a first state condition from the detection component when the detection component registers the first state change; and
returning, via the resistance component, the moveable component from the second position to the first position when the pulling force on the probe falls below the defined amount of force.

13. The method of claim 12, the method further comprising:
triggering, with the triggering component, a second state change registered by the detection component when the moveable component moves from the second position to the first position; and
communicating a second state condition from the detection component when the detection component registers the second state change.

14. The method of claim 13, wherein the resistance component is configured such that the predetermined amount of force is overcome only once a required threshold force of the robotic capture interface has been reached.

15. The method of claim 12, wherein the resistance component is a spring subsystem including at least one spring.

16. The method of claim 12, wherein the state change comprises a physical contact between two components.

17. The method of claim 12, wherein the detection component is configured to register a state change through a non-contact mechanism.

18. The method of claim 17, wherein the detection component is an optical sensor.

19. The method of claim 17, wherein the detection component is a capacitance sensor.

20. A method of assembling a rigidization detection system for detecting a rigidized state of a robotic capture interface between a robotic capture device and a grapple fixture, the method comprising:
providing a grapple fixture base, a probe, a movable component, a resistance component, and a detection component;
coupling the moveable component to the probe such that when probe moves along an axis, the moveable component moves along the same axis, the moveable component including a triggering component;
disposing the resistance component between the moveable component and an interior surface of the grapple fixture base such that the resistance component resists movement of the moveable component along the axis until a predetermined threshold amount of pulling force is applied to the probe along the axis and returns the moveable component to a first position when the pulling force applied to the probe falls below the predetermined threshold amount of force; and
disposing the detection component in an interior compartment of the grapple fixture base, the detection component positioned such that the detection component is triggerable by the triggering component, the detection component configured to, when triggered, register a state change and communicate the state change as a signal.
